(19) United States
(12) Patent Application Publication
(10) Pub. No.: US 2010/0073912 A1
(43) Pub. Date: Mar. 25, 2010

(54) LIGHT EMITTING DEVICE AND DISPLAY DEVICE

(75) Inventors: Kenji Shinozaki, Ichihara-shi (JP); Shuji Gomi, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/595,421

(22) PCT Filed: Apr. 2, 2008
(86) PCT No.: PCT/JP2008/056554

§ 371 Date: Oct. 9, 2009

(30) Foreign Application Priority Data
Apr. 13, 2007 (JP) 2007-106406

(51) Int. Cl. G02F 1/13357; F21V 9/00

(52) U.S. Cl. 362/97.1; 362/231

(57) ABSTRACT

A backlight device (10) is provided with a strip-like light source (30) and a backlight frame (11). In the strip-like light source, a plurality of sub-mounts (40) are arranged in a row on a strip-like substrate having a short width and a long length. In the sub-mount, LEDs of each of red (R), green (G) and blue (B) or LEDs of RGGB are arranged as one unit. In the backlight frame, a plurality of strip-like light sources (30) are two-dimensionally arranged at intervals. The strip-like light sources (30) are arranged so that each position of the sub-mount (40) arranged on the strip-like light source (30) in a first row and each position of the sub-mount (40) arranged on the strip-like light source (30) in the adjacent second row are shifted in the longitudinal direction of the strip-like light source (30). Thus, a display device which has a remarkably reduced area of substrate having the light source rows and excellent uniformity of luminance and chromaticity is provided.

### TECHNICAL FIELD

The present invention relates to a light emitting device and a display device. More specifically, it relates to a light emitting device configured to include light-emitting elements, and a display device using this light emitting device.

### BACKGROUND ART

In recent years, various light emitting devices in which plural solid-state light-emitting elements such as light-emitting diodes (LEDs) are mounted on a substrate for use as a light source have come into practical use. Such light emitting devices are widely used, for example, as a matrix display device in which a matrix of plural LEDs emits light selectively to display characters or images, a backlight for a liquid crystal panel of a liquid crystal display device, or the like.

As a conventional art described in an official gazette, there is an array of light-emitting elements in which plural light-emitting elements are arrayed in line and an array policy based on chromaticity and an array policy based on luminance are combined with each other, in order to thoroughly use, without an occurrence of unevenness of luminance or chromaticity, extra arrays of light-emitting elements that have been produced (for example, refer to Patent Literature 1).

Moreover, as an art of another official gazette, there is a light-emitting diode unit formed by arranging light-emitting diodes in two lines on a substrate. More specifically, the light-emitting diodes are arranged in two lines so that each of the light-emitting diodes is displaced by a half pitch of an arrangement pattern, in desired order, in order to enhance color mixture for obtaining white light, to prevent unevenness of color or luminance, to obtain lower power consumption and long life, and to improve reliability (for example, refer to Patent Literature 2).

Patent Literature 1: Japanese Patent Application Laid Open Publication No. 2006-133708

Patent Literature 2: Japanese Patent Application Laid Open Publication No. 2006-133721

### DISCLOSURE OF THE INVENTION

### Problems to be Solved by the Invention

Here, in some cases, a backlight is formed, for example, by having light-emitting elements arranged in a two-dimensional matrix on a back side of a liquid crystal display panel such as that for a television. For example, there has been widely employed a method of forming the two-dimensional matrix arrangement by entirely mounting a certain number of tile light sources each having m×n (where m and n are integers equal to or larger than 2) light-emitting elements arranged in a two-dimensional matrix on a glass epoxy substrate (glass/epoxy substrate). However, in these backlights used for televisions, televisions of different inch sizes require different sized backlights corresponding thereto, and require changes in shapes of the tile light sources. As a result, component commonality becomes impractical, and reduction in production cost is difficult. Additionally, it becomes necessary to cover, with the tile light sources, an entire face of a base (a chassis) used as a back surface of the television, whereby a cost for the glass/epoxy substrate used as a substrate becomes very large.

Additionally, in a case where a light source is formed by having light-emitting elements, each being any of a red (R), a green (G), or a blue (B) light-emitting element, arranged one after another at regular intervals, mixing the colors thereof to obtain a white color is difficult. In order to sufficiently mix the colors, the R, G and B light-emitting elements need to be closely arranged to each other. Accordingly, in a case where the R, G and B light-emitting elements are arrayed in line so as to be close to each other, it is difficult to make blank spaces between glass/epoxy substrates. For this reason, simply having the light-emitting elements arrayed in line does not contribute to obtain a sufficient effect in cost reduction for the glass/epoxy substrate.

Furthermore, use of so-called high-power LEDs having 1 mm square size or the like, for example, has a problem that these high-power LEDs generate a large amount of heat, and also require a very high cost. Additionally, rather than a case of having light-emitting points with high luminance scattered about, a case of having a large number of light-emitting points with low luminance has advantages in luminance and chromaticity uniformity, and enables the formation of a thinner backlight. From these points of view, it is preferable to employ small chip LEDs for a backlight. However, in order to obtain the same brightness as that of the high-power LEDs by employing the small chip LEDs, it is necessary that a large number of the LEDs be arrayed. If a large number of the LEDs are used, even in a case where not the two-dimensional arrangement but the one-line arrangement is employed for example, this simple usual alignment eventually requires that an entire face of a chassis be covered with a glass/epoxy substrate.

An object of the present invention is to provide a display device that facilitates mixing of RGB colors to obtain a white color and also that has excellence in uniformity in luminance and chromaticity.

Additionally, another object thereof is to largely reduce an area of a substrate for a light source row to realize installability of other members as well as cost reduction.

### Means for Solving the Problems

A light emitting device to which the present invention is applied is provided with: a strip-like light source having a strip-like substrate on which a plurality of units each having, as a single unit, any one of a set of one red (R), one green (G) and one blue (B) light-emitting elements arranged therein and a set of one red (R), one green (G), one green (G) and one blue (B) light-emitting elements arranged therein are arranged in line, the strip-like substrate having a short width and a long length; and a frame on which a plurality of the strip-like light sources are arranged two-dimensionally at intervals.

Here, the plurality of strip-like light sources are arranged on the frame so that, in a longitudinal direction of the strip-like light source, positions of the plurality of units arranged on the strip-like light source in a first row may be shifted from positions of the units arranged on the strip-like light source in a second row adjacent to the first row.

On the frame, each of the positions of the plurality of units arranged on the strip-like light source in the first row is shifted from corresponding one of the positions of the plurality of units arranged on the strip-like light source in the second row adjacent to the first row by substantially half of a pitch between the plurality of units arranged on each of the strip-like light sources.

Moreover, two of the units that are arranged on a predetermined one of the strip-like light sources, and one of the units that is arranged on another one of the strip-like light sources in another row adjacent to the predetermined strip-like light source and that is the closest to the two of the units, have such a positional relationship as to form a substantially equilateral triangle. This configuration has an advantage of excellent uniformity of luminance and chromaticity, as compared to a case where the present configuration is not adopted. In particular, the present configuration is effective in a case where the units are one-dimensionally arranged on the substrate in line, since it is more difficult to obtain the uniformity of luminance and chromaticity in the one-dimensional arrangement than in the two-dimensional arrangement.

The strip-like light source is provided with the plurality of units arranged on the strip-like substrate, and is provided with a terminal on the strip-like substrate, the terminal being electrically connected to the plurality of units. In particular, the terminal provided on the strip-like light source is arranged on the strip-like substrate with a longitudinal direction thereof being set to the same direction as a direction of the row of the plurality of units provided on the strip-like light source. This configuration has excellence in reduction of an area of the strip-like substrate made of, for example, glass/epoxy substrate. In addition, intervals between the units are widened by causing each unit on the strip-like light source to be smaller. Specifically, each unit is caused to be smaller by gathering RGB or RGGB.

The light emitting device is further provided with a relay substrate that is arranged between the plurality of strip-like light sources on the frame and that is electrically connected to the terminal of each of the light-emitting sources. By adopting the strip-like light sources, gaps on the frame are obtained and are utilized. Thus, improvement of the installability may be achieved, for example. In addition, the relay substrate is mounted on the gap on the frame instead of the back side of the frame in the conventional technique, and thus the device can be thinner.

A display device to which the present invention is applied is provided with: a display panel that displays an image; and a light emitting device that is provided on a back side of the display panel, the light emitting device including: a strip-like light source having a strip-like substrate on which a plurality of units each having, as a single unit, among red (R), green (G) and blue (B) light-emitting elements, anyone of a set of one red (R), one green (G) and one blue (B) light-emitting elements arranged therein and a set of one red (R), one green (G), one green (G) and one blue (B) light-emitting elements arranged therein are arranged in line, the strip-like substrate having a short width and a long length; and a frame on which a plurality of the strip-like light sources are arranged two-dimensionally with gaps, each of the gaps between rows of the plurality of strip-like light sources being larger than the width of the strip-like substrate.

Here, by attachment of the plurality of strip-like light sources to the frame, heat from the light-emitting elements arranged in the units is allowed to be conducted to the frame through through-holes of the plurality of strip-like light sources, and through heat releasing layers each provided on a back surface which is opposite to a front surface on which the light-emitting elements are arranged. This configuration has an advantage of preferable heat release by use of a simple fixing unit such as screws.

In the strip-like light source of the light emitting device, reflow is performed for an electrical connection to the plurality of units and a connection used for heat conduction from the plurality of units. The present configuration achieves preferable heat release even when attachment is efficiently performed.

### ADVANTAGES OF THE INVENTION

According to the present invention, it is possible to largely reduce an area of a substrate for a light source row, and to provide a display device having excellence in uniformity in luminance and chromaticity even in the case of largely reducing the area.

### BEST MODES FOR CARRYING OUT THE INVENTION

Hereinafter, exemplary embodiments of the present invention will be described in detail with reference to the accompanying drawings.

FIG. 1 is a view showing an entire configuration of a display device to which an exemplary embodiment is applied. The display device to which the present exemplary embodiment is applied includes a liquid crystal display module 20 having a display panel, and a backlight device 10 as a light emitting device emitting light to the liquid crystal display module 20, which is provided on a back side of the liquid crystal display module 20 (a lower side in the FIG. 1).

The backlight device 10 includes a backlight frame 11 as a base (chassis) that contains a light-emitting portion. The backlight frame 11 has a two-dimensional arrangement of strip-like light sources 30. In each of the strip-like light sources 30, light-emitting diodes (hereinafter, referred to as LEDs) are arranged in line. In addition, relay substrates 60 are each arranged between adjacent arrays of the strip-like light sources 30. Each of the relay substrates 60 is used for electrically connecting the respective LEDs in the strip-like light sources 30 with an external device.

The backlight device 10 includes, as a laminated body of optical films, a diffusion plate 13 that is a film (or a plate) scattering and diffusing light to equalize the lightness over the entire surface, and prism sheets 14 and 15 that have a light collection effect to the front. In addition, the backlight device 10 includes a luminance improvement film 16 with a diffusion and reflection type, for improving the luminance.

On the other hand, the liquid crystal display module 20 includes a liquid crystal panel 21 as one type of a display panel that is configured by two glass substrates sandwiching liquid crystal in between, and polarization plates 22 and 23 for restricting the oscillation of optical wave to a given direction, which are each laminated on each glass plate of the liquid crystal panel 21. The display device includes peripheral members (not shown in the figure) such as an LSI (Large Scale Integration) for driving, mounted thereon. For example, the liquid crystal panel 21 as a display panel in a limited sense includes various components not shown in the figure. For example, the two glass plates have display electrodes, active elements such as a thin film transistor (TFT), liquid crystal, a spacer, sealant, an orientation film, a common electrode, a protective film, a color filter, and others, none of which is shown in the figure.

The structural unit of the backlight device 10 as a light emitting device is selected in an arbitrary way. For example, a unit only including the backlight frame 11 with the strip-like light sources 30 may be called as the “backlight device (backlight)” and distributed as a “light emitting device” not including the laminated body of the optical films such as the diffusion plate 13 and the prism sheets 14 and 15.

FIG. 2 is a top view of the backlight device 10 when viewed from the liquid crystal display module 20 side in FIG. 1. The backlight device 10 shown in FIG. 2 employs a direct backlight structure in which light sources are placed directly under a back surface of the liquid crystal display module 20. Additionally, in this backlight structure, light-emitting elements are arrayed substantially evenly throughout an entire back surface of the liquid crystal display module 20.

The backlight frame 11 of the backlight device 10 has a housing structure made of, for example, anyone of aluminum, magnesium and iron, or a metal alloy containing those materials. In order to favorably release heat of the LEDs, it is desirable that the backlight frame 11 has high heat conductivity. Additionally, on an inner side of the backlight frame 11, the plural strip-like light sources 30 and the plural relay substrates 60 are arranged. In the example in FIG. 2, 16 rows each having four strip-like light sources 30 arranged therein, are provided. In each of the strip-like light sources 30, sub-mounts 40 are arranged in line, the sub-mounts 40 each having plural LEDs arranged as one unit therein. Each of these sub-mounts 40 is a unit substrate (a unit) in which three LEDs including red (R), green (G) and blue (B) LEDs or four LEDs including red (R), green (G), green (G) and blue (B) LEDs are arranged as one unit. Additionally, the relay substrates 60 are substrates each provided with driving power source supply circuits that supply power for driving the LEDs arranged on the strip-like light sources 30.

The strip-like light sources 30 in each rows are arranged so that positions of the sub-mounts 40 in the strip-like light sources 30 in the first row (for example, the strip-like light sources 30 in the first one of rows) may be shifted in a longitudinal direction of the strip-like light sources 30 from positions of the sub-mounts 40 in the strip-like light sources 30 in the second row (for example, the strip-like light sources 30 in the second one of rows) adjacent to the first row. In particular, the strip-like light sources 30 in adjacent two rows are arranged so as to be shifted to each other by a distance corresponding to a half pitch of a distance (pitch) between the sub-mounts 40 next to each other, and a distance between each adjacent two of the rows is determined so that distances between the sub-mounts 40 adjacent to each other may be equal. That is, as shown in FIG. 2, the strip-like light sources 30 are two-dimensionally arranged in the backlight frame 11 so that three sub-mounts 40, which are a sub-mount 40-1 in the first one of the rows, and sub-mounts 40-2 and 40-3 of the strip-like light source 30 laid in the second one of the rows together form a substantially equilateral triangle.

FIGS. 3A to 3C are outline views showing a configuration of each of the strip-like light sources 30. FIG. 3A is a top view seen from the liquid crystal display module 20; FIG. 3B is a side view thereof; and FIG. 3C is a backside view thereof seen from a side thereof being in contact with the backlight frame 11. A substrate 31 of the strip-like light source 30 is formed of a glass epoxy substrate (glass/epoxy substrate) cut into, for example, a long and thin shape having a width of approximately 10 mm and a length of approximately 160 mm. On this substrate 31, plural sub-mounts 40 (six sub-mounts 40 in FIGS. 3A to 3C) are arranged at regular intervals. An interval, as a center-to-center distance, between the sub-mounts 40 next to each other is, for example, about 30 mm.

In these measurement relations, if the strip-like light sources 30 are arranged so that the three sub-mounts 40, that is, the sub-mount 40-1 in the first one of the rows, and the sub-mounts 40-2 and 40-3 of the strip-like light source 30 placed in the second one of the rows, form a substantially equilateral triangle as shown in FIG. 2, the strip-like light sources 30 in each row are arranged to keep a large gap between themselves and the strip-like light sources 30 of the adjacent row, the gap being larger than the width (10 mm) of the strip-like substrate. That is, if the strip-like light sources 30 are arranged so that the sub-mounts 40 form a substantially equilateral triangle as has been mentioned above, an interval, as a center-to-center distance, between each adjacent two of the rows becomes about 26 mm, and a gap between each adjacent two of the rows excluding the glass/epoxy substrates, becomes about 16 mm. As has been described above, by arranging the plural strip-like light sources 30 two-dimensionally so as to have larger gaps than the width of the substrate 31 used for each of the strip-like light sources 30, an enlarged effect in saving glass/epoxy substrates becomes obtainable. Moreover, degrees of freedom with respect to wirings and the like are allowed to be increased.

Here, on the substrate 31, a terminal 32 used for supplying electric power to the sub-mounts 40 thereon and for inputting control signals for operating ON/OFF thereof and the like is provided. The terminal 32 is provided on the substrate 31 so that a longitudinal direction thereof becomes substantially parallel with a direction of a row in which the sub-mounts 40 are arrayed, that is, so that the longitudinal direction thereof extend in the same direction as the direction of the row. Additionally, the substrate 31 is provided with screw holes 33 used for fixing the strip-like light source 30 to the backlight frame 11. As shown in FIG. 3C, a heat releasing layer 35 is formed on a back surface of the substrate 31. The heat releasing layer 35 is used for releasing heat from the LEDs arrayed on the sub-mounts 40 and is made of, for example, copper or the like. This heat releasing layer 35 and a heat releasing pattern (described later) formed on a front surface of the substrate 31 are connected to each other through through-holes 34, whereby heat from the LEDs are conducted to the heat releasing layer 35.

FIGS. 4A and 4B are views for illustrating a structure of each of the sub-mounts 40 which is a unit substrate. The sub-mount 40 includes: a substrate 41 having a size of, for example, about 5 mm square; and wiring patterns 42 formed on a front surface of the substrate 41 by resist processing of copper plating having been subjected to pattern processing. Additionally, the sub-mount 40 is provided with red (R), green (G) and blue (B) LEDs 43 (43R, 43G and 43B), each of which is connected to corresponding ones of the wiring patterns 42 through wires 44 by a wire bonding. In addition, after the LEDs 43 (43R, 43G and 43B) are wired, a lens 45 is applied thereon for resin sealing.

Furthermore, as shown in FIG. 4B, back-surface wiring patterns 46 and a heat releasing pattern 47 are formed on a back surface of the substrate 41. Each of the wiring patterns 42 which are formed on the front surface of the substrate 41, and the corresponding one of the back-surface wiring patterns 46 are electrically connected to each other through each of wiring through-holes (described later). Additionally, the heat releasing pattern 47 is connected with the R, G and B LEDs 43 through a heat-releasing through-hole (described later) made of, for example, copper, and thereby allows conduction of heat from the R, G and B LEDs 43 (43R, 43G and 43B).

The plural sub-mounts 40 each being described above and each having the structure shown in FIGS. 4A and 4B are mounted on a large sized substrate sheet (for example, about 110 mm by 60 mm) determined in accordance with the number of cut pieces, to form a package substrate (not shown in the figure). Then, the package substrate thus formed is cut into pieces each having a size of about 5 mm square, so that the sub-mounts 40 shown in FIGS. 4A and 4B are produced on a large scale at a time.

FIG. 5 is a partial cross-sectional view showing a state where the strip-like light source 30, which has the sub-mounts 40 arranged thereon, is mounted to the backlight frame 11. The back-surface wiring patterns 46 respectively formed on back surfaces of the substrates 41 of the sub-mounts 40 are connected to the wiring patterns 42 through wiring through-holes 48. Meanwhile, the heat releasing pattern 47 formed on the back surface of the substrate 41 in the same manner is configured so as to allow heat of the LEDs 43 to be conducted thereto through a heat-releasing through-hole 49. Then, those back-surface wiring patterns 46 and the heat releasing pattern 47 are connected to wiring patterns 36 and heat releasing patterns 37 with bumps 51 and 52 respectively interposed in between. Here, the wiring patterns 36 and the heat releasing patterns 37 are formed on the front surface of the substrate 31. More specifically, the bumps 51 and 52 are placed on the wiring patterns 36 and the heat releasing patterns 37 formed on the front surface of the substrate 31, respectively, and then caused to go through a reflow oven with the sub-mount 40 being placed thereon so that the bumps 51 and 52 and the sub-mount 40 are connected together.

Here, the wiring patterns 36 formed on the front surface of the substrate 31 are connected to the terminal 32 shown in FIG. 3A. Because of this, when the back-surface wiring patterns 46 of the sub-mount 40 and the wiring patterns 36 are connected to each other, each of the LEDs 43 (43R, 43G and 43B) and the terminal 32 are electrically connected to each other. Additionally, heat of the LEDs 43 (43R, 43G and 43B) is conducted to the heat releasing layer 35 through the heat-releasing through-hole 49 lying directly under each of the LEDs 43 (43R, 43G and 43B), the heat releasing pattern 47 connected to the heat-releasing through-hole 49; the bumps 52 having been subjected to reflow; the heat releasing patterns 37; and the through-hole 34.

The strip-like light source 30, on which the sub-mount 40 has been mounted, is mounted on the backlight frame 11 in such a way that a heat-releasing sheet 54, for example, is sandwiched between the strip-like light source 30 and the backlight frame 11 by using screws 53 screwed at portions corresponding to the screw holes 33 (refer to FIGS. 3A to 3C). As shown in FIG. 3C, the heat releasing layer 35 is formed around locations where the screw holes 33 exist. For this reason, fixing the sub-mount 40 to the backlight frame 11 by use of the screws 53 causes heat having been conducted to the heat releasing layer 35 from the LEDs 43 (43R, 43G and 43B) to conduct favorably to the backlight frame 11.

The strip-like light source 30, to which the sub-mounts 40 have been mounted, is mounted to the backlight frame 11 in the above described manner, whereby the backlight device 10 as shown in FIG. 2 is formed. In the strip-like light source 30, as shown in FIG. 4A, the red (R), green (G) and blue (B) LEDs 43 (43R, 43G and 43B) are arranged close to one another, and are formed into one unit. Thereby, obtaining a white color through favorable color mixing becomes feasible. Additionally, favorable luminance becomes obtainable as a whole even by use of light-emitting points with low luminance, and thus a light emitting device having excellence in luminance and chromaticity uniformity is allowed to be provided. Note that, other than a combination of RGB, it is preferable that one unit be formed by arranging the RGGB LEDs 43 close to one another.

Moreover, in the present exemplary embodiment, as shown in FIG. 3A, the strip-like light source 30 is formed by arranging these sub-mounts 40 in line. Since the width of this strip-like light source 30 is sufficiently smaller than an interpitch distance of the sub-mounts 40, the backlight frame 11 has regions (blank spaces) each having no glass/epoxy substrates (the strip-like light sources 30) mounted thereon even in a case where the sub-mounts 40 adjacent to each other are arranged so that the sub-mounts 40-1, 40-2 and 40-3 may form an equilateral triangle as shown in FIG. 2. Because of the existence of the regions having no glass/epoxy substrates mounted thereon, a total area of the glass/epoxy substrates is saved. Moreover, the existence of the blank spaces allows, for example, the relay substrates 60 to be arranged in spaces between each adjacent two of the rows in each of which the strip-like light sources 30 are arrayed, whereby degree of freedom in wiring is increased.

Note that, in the present exemplary embodiment, as shown in FIG. 3A, the terminal 32 of each of the strip-like light sources 30 is formed on the front surface side on which the sub-mounts 40 are arrayed. In the case where the sub-mounts 40 are arranged on the front surface side, it is only necessary that the backlight frame 11 has the relay substrates 60 provided on a side thereof where the strip-like light sources 30 are formed as shown in FIG. 2 so that the terminals 32 and corresponding one of the relay substrates 60 are connected to each other on the front surface side.

Otherwise, instead of this configuration, the terminal 32 of the strip-like light source 30 shown in FIG. 3A may be provided on the back surface of the strip-like light source 30. In such a case, electrical connection may be made from a back surface of the backlight frame 11 with a cutout hole (not shown in the figure) for the terminal 32 formed in the backlight frame 11.

Furthermore, by setting, as appropriate, a longitudinal dimension of each strip-like light source 30 and array intervals of the sub-mounts 40, the strip-like light sources 30 are allowed to be shared, for example, even when used as different inch-sized backlights of televisions.

Note that, in the above-described exemplary embodiment, a description has been given by taking, as an example, a case where unit substrates are used as the respective sub-mounts 40. However, a unit may be formed without using a sub-mount substrate. For example, a case is conceivable where LEDs constituting one unit are arranged directly on a strip-like light source substrate so as to be close to each other. In such a case, an aspect in which the LEDs are directly mounted on the strip-like light source substrate and connected to the strip-like light source substrate by wire bonding is given as one example.

### BRIEF DESCRIPTION OF THE DRAWINGS

FIG. 1 is a view showing an entire configuration of a display device to which an exemplary embodiment is applied.

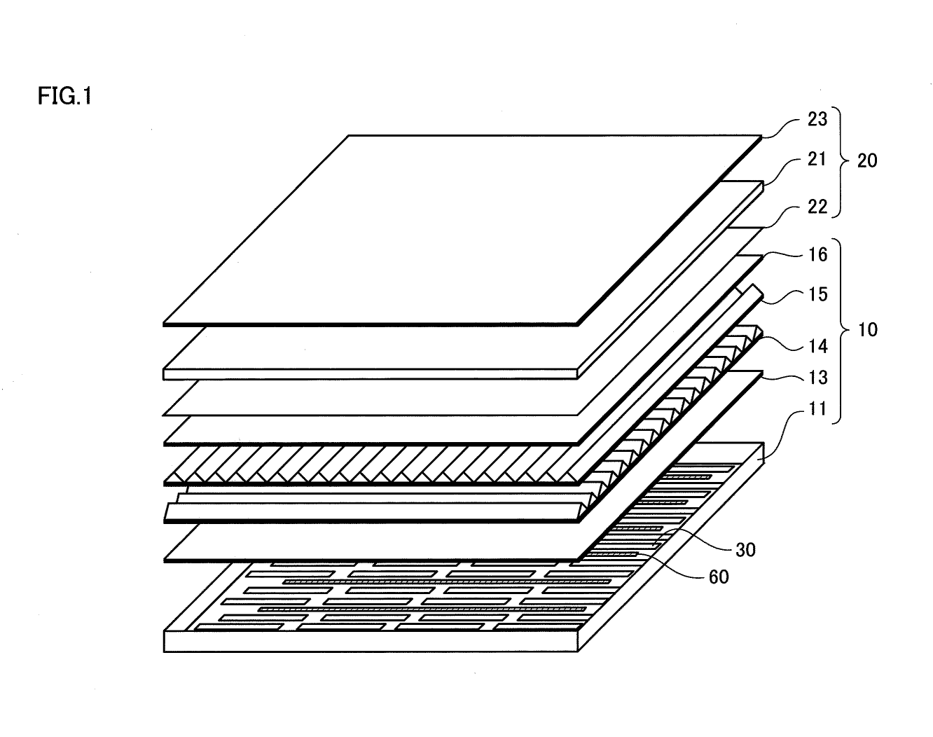

FIG. 2 is a top view of the backlight device when viewed from the liquid crystal display module side in FIG. 1.

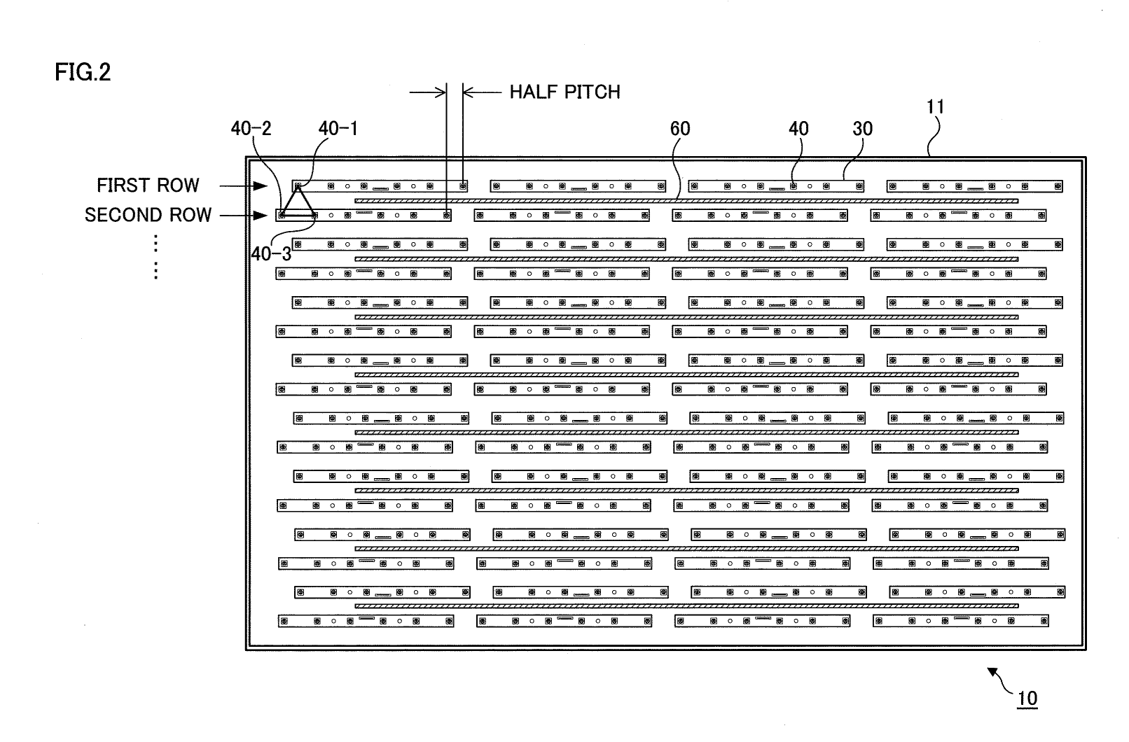

FIGS. 3A to 3C are outline views showing a configuration of each of the strip-like light sources.

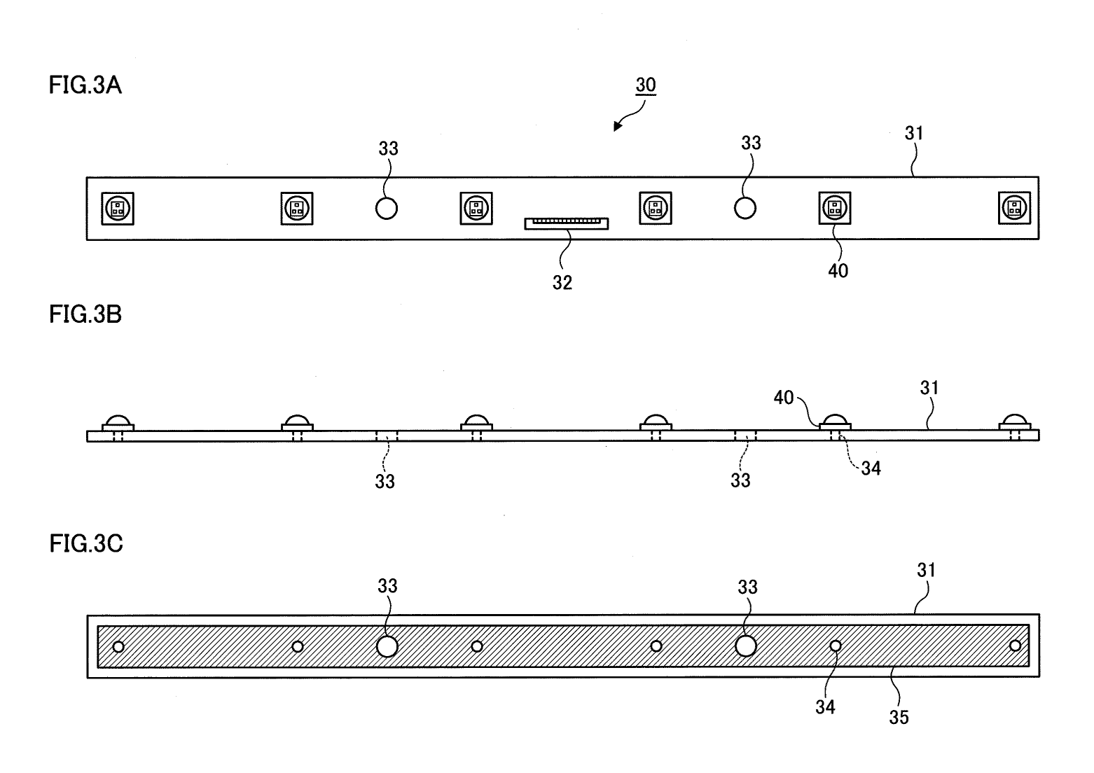

FIGS. 4A and 4B are views for illustrating a structure of each of the sub-mounts which is a unit substrate.

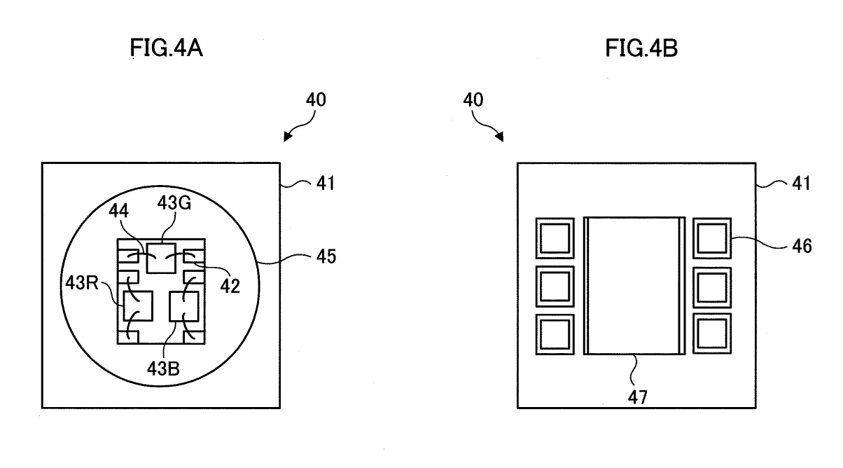

FIG. 5 is a partial cross-sectional view showing a state where the strip-like light source, which has the sub-mounts arranged thereon, is mounted to the backlight frame.

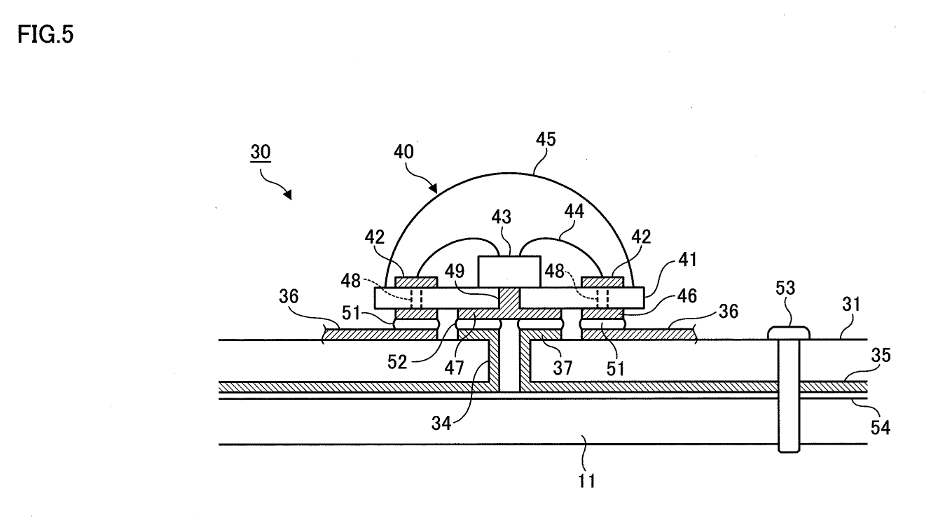

### DESCRIPTION OF REFERENCE NUMERALS AND SIGNS

10 . . . backlight device, 11 . . . backlight frame, 20 . . . liquid crystal display module, 30 . . . strip-like light source, 31 . . . substrate, 40 . . . sub-mount, 41 . . . substrate, 43 . . . LED, 60 . . . relay substrate

1. A light emitting device comprising:
a strip-like light source having a strip-like substrate on which a plurality of units each having, as a single unit, any one of a set of one red (R), one green (G) and one blue (B) light-emitting elements arranged therein and a set of one red (R), one green (G), one green (G) and one blue (B) light-emitting elements arranged therein are arranged in line, the strip-like substrate having a short width and a long length; and
a frame on which a plurality of the strip-like light sources are arranged two-dimensionally at intervals.

2. The light emitting device according to claim 1, wherein, the plurality of strip-like light sources are arranged on the frame so that, in a longitudinal direction of the strip-like light source, positions of the plurality of units arranged on the strip-like light source in a first row may be shifted from positions of the units arranged on the strip-like light source in a second row adjacent to the first row.

3. The light emitting device according to claim 2, wherein, on the frame, each of the positions of the plurality of units arranged on the strip-like light source in the first row is shifted from corresponding one of the positions of the plurality of units arranged on the strip-like light source in the second row adjacent to the first row by substantially half of a pitch between the plurality of units arranged on each of the strip-like light sources.

4. The light emitting device according to claim 1, wherein two of the units that are arranged on a predetermined one of the strip-like light sources, and one of the units that is arranged on another one of the strip-like light sources in another row adjacent to the predetermined strip-like light source and that is the closest to the two of the units, have such a positional relationship as to form a substantially equilateral triangle.

5. The light emitting device according to claim 1, wherein the strip-like light source is provided with the plurality of units arranged on the strip-like substrate, and is provided with a terminal on the strip-like substrate, the terminal being electrically connected to the plurality of units.

6. The light emitting device according to claim 5, wherein the terminal provided on the strip-like light source is arranged on the strip-like substrate with a longitudinal direction thereof being set to the same direction as a direction of the row of the plurality of units provided on the strip-like light source.

7. The light emitting device according to claim 5, further comprising a relay substrate that is arranged between the plurality of strip-like light sources on the frame and that is electrically connected to the terminal of each of the light-emitting sources.

8. A display device comprising:
a display panel that displays an image; and
a light emitting device that is provided on a back side of the display panel,
the light emitting device including:
a strip-like light source having a strip-like substrate on which a plurality of units each having, as a single unit, among red (R), green (G) and blue (B) light-emitting elements, any one of a set of one red (R), one green (G) and one blue (B) light-emitting elements arranged therein and a set of one red (R), one green (G), one green (G) and one blue (B) light-emitting elements arranged therein are arranged in line, the strip-like substrate having a short width and a long length; and
a frame on which a plurality of the strip-like light sources are arranged two-dimensionally with gaps, each of the gaps between rows of the plurality of strip-like light sources being larger than the width of the strip-like substrate.

9. The display device according to claim 8, wherein, by attachment of the plurality of strip-like light sources to the frame, heat from the light-emitting elements arranged in the units is allowed to be conducted to the frame through through-holes of the plurality of strip-like light sources, and through heat releasing layers each provided on a back surface which is opposite to a front surface on which the light-emitting elements are arranged.

10. The display device according to claim 8, wherein, in the strip-like light source of the light emitting device, reflow is performed for an electrical connection to the plurality of units and an connection used for heat conduction from the plurality of units.
